(19) United States
(12) Patent Application Publication
(10) Pub. No.: US 2019/0137059 A1
(43) Pub. Date: May 9, 2019

(54) ELECTRIC FIREPLACE PROVIDING 3D FLAME EFFECT

(71) Applicant: Zhongshan Paite Electric Appliances Co., Ltd., Zhongshan (CN)

(72) Inventor: Jiuqing Zhou, Zhongshan (CN)

(21) Appl. No.: 15/911,210

(22) Filed: Mar. 5, 2018

(30) Foreign Application Priority Data
Nov. 9, 2017 (CN) 201721484247.0
Nov. 9, 2017 (CN) 201721484430.0

(51) Int. Cl. F21S 10/04; F24B 1/18

(52) U.S. Cl. CPC F21S 10/046; F24B 1/1808

(57) ABSTRACT

The invention relates to the field of electric heating appliances, specifically an electric fireplace providing a 3D flame effect, which comprises a housing, and inside, decorative firelogs, embers, a first light projector, a second light reflector, a first light-emitting source, a second light-emitting source and a flame-imaging device; wherein the first light projector comprises a first actuator and a revolving drum connected with an output shaft of the first actuator, wherein the revolving drum scatters the light emitted from the first light-emitting source onto the decorative firelogs and the embers; wherein the second light reflector reflects the light emitted from the second light-emitting source onto the flame-imaging device. The projection of both lights simulates a realistic 3D effect of a burning flame.

### CROSS-REFERENCE TO RELATED APPLICATIONS

This application claims the benefit of Chinese Utility Model Application No. 201721484247.0 filed, on Nov. 9, 2017, and No. 201721484430.0 filed on Nov. 9, 2017, the contents of which are incorporated herein by reference.

### FIELD OF THE INVENTION

The invention relates to the field of household heating appliances, specifically an electric fireplace providing a 3D-flame effect.

### BACKGROUND OF THE INVENTION

As a household heating appliance, the electric fireplace has the characteristics including good sanitation, safety and reliability, convenience of installing and removing, high combustion efficiency and etc. Compared with the firewood and the gas fireplace, the electric fireplace doesn't generate any soot difficult to remove, unpleasant odor, or noise from burning flame. The electric fireplace can not only save the heating cost, but also display an elegant decorative effect while safely bringing warmth and great comfort. Switch on nicely, a magical flame-effect will be instantly displayed. After convenient installation, the magnificent flame will bring you a nice mood by home decoration.

In order to simulate a realistic effect of a burning flame, the existing electric fireplaces are equipped with flame simulators. However, these flame simulators lack realistic flame effect and have poor simulated effect of burning flame. These disadvantages limit the popularization of electric fireplaces.

### SUMMARY OF THE INVENTION

The invention aims to provide an electric fireplace providing a highly simulated and lifelike 3D flame effect.

In order to solve the problems mentioned above, the invention provides an electric fireplace providing a 3D flame effect, which comprises a housing, and inside, decorative firelogs, embers, a first light projector, a second light reflector, a first light-emitting source, a second light-emitting source and a flame-imaging device; wherein the first light projector comprises a first actuator and a revolving drum connected with an output shaft of the first actuator, wherein the revolving drum is used. for scattering the light emitted from the first light-emitting source onto the decorative firelogs and the embers; wherein the second reflector is used for reflecting the light emitted from the second light-emitting source onto the flame-imaging device.

Preferably, the revolving m is a transparent revolving m which is polygonally-shaped in cross-section.

Preferably, the revolving drum has a plurality of light transmitting apertures.

Preferably, the light transmitting apertures are embedded with condensing lens.

Preferably, the first light-emitting source is arranged inside the revolving drum.

Preferably, the first light-emitting source is arranged outside the revolving drum.

Preferably, the second light reflector comprises a second actuator, a rotation shaft connected with an output shaft of the second actuator and a plurality of groups of reflector plates arranged along an axis of the rotation shaft, and each group of reflector plates comprises a plurality of reflector plates which are radially mounted on the rotation shaft.

Preferably, the flame-imaging device comprises a flame-shaped plate and a flame-imaging screen, and the light reflected by the second light reflector can be projected onto the flame-imaging screen through the flame-shaped plate.

Preferably, the second light reflector is arranged in the lower part of the housing, the flame-imaging screen is arranged on the back wall of the housing, and the flame-shaped plate is slantingly disposed between the second light reflector and the flame-imaging screen.

Preferably, the second light reflector is arranged in the lower rear part of the housing, the flame-imaging screen is vertically arranged in the middle of the housing and behind the decorative firelogs and the embers, and the flame-shaped plate is slantingly arranged between the second light reflector and the flame-imaging screen.

Preferably, the decorative firelogs and the embers are installed in a lower part of the housing by the firelog bed, the first light projector is in the lower front of the decorative firelogs and the embers, both of the second light reflector and the flame-imaging device are arranged behind the decorative firelogs and the embers, or behind them at a lower position.

Preferably, the housing is further arranged with an electric warm air blower in an upper part.

Preferably, the housing is further provided with an inspection window in the front wall.

In the electric fireplace providing a 3D effect in the invention, the first light projector scatters the light emitted from the light-emitting source onto the decorative firelogs and the embers, to simulate the change of flickering brightness during the burning process of the firewood, the second light reflector reflects the light emitted from the light-emitting source onto the flame-imaging device, to simulate a flame effect of the burning firewood. The combination of the two effects forms a realistic 3D effect of burning flame.

### BRIEF DESCRIPTION OF THE DRAWINGS

FIG. 1 is a schematic sectional view of an electric fireplace according to embodiment 1 of the invention;

FIG. 2 is a schematic sectional view of the electric fireplace according to embodiment of the invention, but taken in a different direction;

FIG. 3 is a schematic sectional view of an electric fireplace according to embodiment 2 of the invention;

FIG. 4 is a schematic sectional view of an electric fireplace according to embodiment 3 of the invention;

FIG. 5 is a schematic sectional view of the electric fireplace according to embodiment 3 of the invention, but taken in a different direction;

FIG. 6 is a schematic sectional view of an electric fireplace according to embodiment 4 of the invention.

In the drawings: 1. housing; 11. inspection window; 12. light screen; 2. decorative firelogs; 3. embers; 4. first light projector; 41. first actuator; 42. revolving drum; 5. second light reflector; 51. rotation shaft; 52. reflector plates; 61. first light-emitting source; 62. second light-emitting source; 7, flame-imaging device; 71. flame-shaped plate; 72. flame-imaging screen 8. firelog bed; 9. electric warm air blower.

### DETAILED DESCRIPTION OF ILLUSTRATED EMBODIMENTS

The invention will be further illustrated in the detailed description in conjunction with the drawings and the embodiments. The following embodiments are intended to illustrate the invention, but not to restrict the scope of the invention,

Referring to FIGS. 1-6, an electric fireplace providing a 3D flame effect according to preferred embodiments of the invention is schematically illustrated, which comprises a housing 1, and inside, decorative firelogs 2, embers 3, a first light projector 4, a second light reflector 5, a first light-emitting source 61, a second light-emitting source 62, a flame-imaging device 7, a firelog bed 8, an electric warm air blower 9, wherein the first light projector 4 is used for scattering the light emitted from the first light-emitting source 61 onto the decorative firelogs 2 and the embers 3, to simulate the change of flickering brightness during the burning process of the firewood, and the second light reflector 5 is used for reflecting the light emitted from the second light-emitting source 62 onto the flame-imaging device 7, to simulate the flame effect of the burning firewood. By the combination of the two, a realistic 3D effect of burning flame is provided, which can be seen through the inspection window 11. It looks like the decorative firelogs 2 inside the housing 1 actually burns and creates a raging flame like the real firewood. The electric warm air blower 9 blows warm air, to simulate the heat generated from burning flame, and therefore making the electric fireplace which simulates burning firewood. and. supplies heat more realistic. The followings are several preferred embodiments of the electric fireplace providing 3D flame effect of the invention.

### Embodiment 1

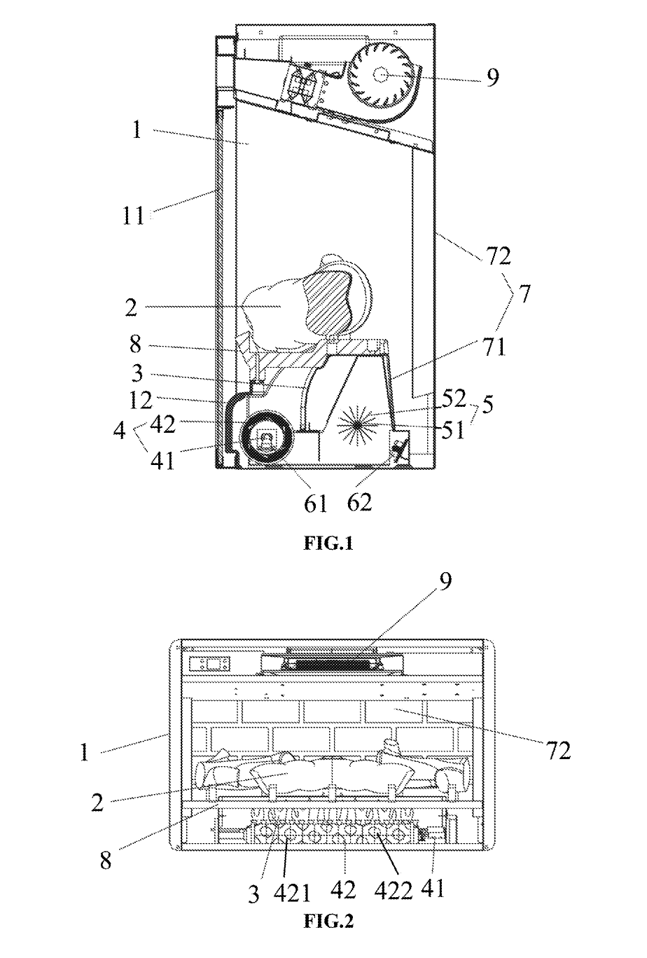

As illustrated in FIG. 1 and FIG. 2, in the electric fireplace in this embodiment, the decorative firelogs 2 and the embers 3 are installed in the lower part of the housing 1 by means of the firedog 8. The first light projector 4, the second light reflector 5, the first light-emitting source 61 and the second light-emitting source 62 are all arranged under the decorative firelogs 2 and the embers 3, wherein the first tight projector 4 is below a front part of the decorative firelogs 2 and the embers 3, the second light reflector 5 is below a rear part of the decorative firelogs 2 and the embers 3. The flame-imaging device 7 is arranged behind the decorative firelogs 2 and the embers 3. The electric warm air blower 9 is arranged in the upper part of the housing 1. The inspection window 11 is arranged in the front wall of the housing 1. The housing 1 is further equipped with a light screen 12 at the lower part of the front wall, to prevent the leakage of the light of the first light-emitting source 61 from the housing 1.

Specifically, the first light projector 4 comprises a first actuator 41 (preferably an electric motor) and a revolving drum 42 connected with an output shaft of the first actuator 41. The revolving drum 42 is a transparent revolving drum which is polygonally-shaped in cross-section, The first light-emitting source 61 is arranged inside the revolving drum 42, wherein the light produced by the first light-emitting source 61 scatters onto an interior wall of the revolving drum 42, and then refracted onto the decorative firelogs 2 and the embers 3 through the interior wall of the revolving drum 42. Due to the revolving drum 42 which is driven to rotate by means of the first actuator 41, the light produced by the first light-emitting source 61 can he refracted onto the decorative firelogs 2 and the embers 3 in a flickering manner, such that the change of flickering brightness during the burning process of the firewood can be simulated.

Optionally, the revolving drum 42 can be opaque, the side wall of the revolving drum 42 has a plurality of light transmitting apertures, through which the light produced by the first light-emitting source 61 is diffracted onto the decorative firelogs 2 and the embers 3. As the first actuator 41 drives the revolving drum 42 to rotate, the light produced by the first light-emitting source 61 is diffracted onto the decorative firelogs 2 and the embers 3 in a flickering manner, to simulate the change of flickering brightness during the burning process of the firewood. In order to make the burning effect more realistic, the light transmitting apertures can he embedded with condensing tens, through which the light is diffracted onto the decorative firelogs 2 and the embers 3.

The second light reflectors comprises a second actuator (preferably an electric motor), a rotation shaft 51 connected with an output shaft of the second actuator, and a plurality of groups of reflector plates arranged along an axis of the rotation shaft 51. Each group of reflector plates comprises a plurality of reflector plates 52 which are radially mounted on the rotation shaft 51. The second tight-emitting source 62 is arranged behind the second light reflector 5 at a lower position.

The flame-imaging device 7 comprises a flame-shaped plate 71 and a flame-imaging screen 72. In this embodiment, the flame-imaging screen 72 is mounted on the back wall of the housing 1, the flame-shaped. plate 71 is slantingly arranged between the second. light reflector 5 and the flame-imaging screen 72, and is behind the bottom of the decorative firelogs 2 and the embers 3. As the second actuator drives the rotation shaft 51 to rotate, the reflector plates 52 rotate with the rotation shaft 51, such that the light emitted from the second light-emitting source 62 to the reflector plates 52 can be intermittently reflected onto the flame-shaped plate 71, and then the reflected tight can be projected onto the flame-imaging screen 72 through the flame-shaped plate 71, to simulate a realistic flame effect of burning firewood.

The working principle of the electric fireplace providing a 3D flame effect in this embodiment of the invention is as follows: the light emitted from the first light-emitting source 61 is reflected onto the decorative firelogs 2 and the embers 3 by the first light projector 4; as the first actuator 41 drives the revolving drum 42 to rotate, the light produced by the first light-emitting source 61 is projected onto the decorative firelogs 2 and the embers 3 in a flickering manner, to simulate the change of flickering brightness during the burning process of the firewood; the reflector plates 52 of the second light reflector 5 intermittently reflect the light emitted from the second light-emitting source 62 onto the flame-shaped plate 71, through which the reflected light is projected on the flame-imaging screen 72, to simulate a realistic flame effect of burning firewood. The combination of the two effects forms a realistic 3D effect of burning flame.

### Embodiment 2

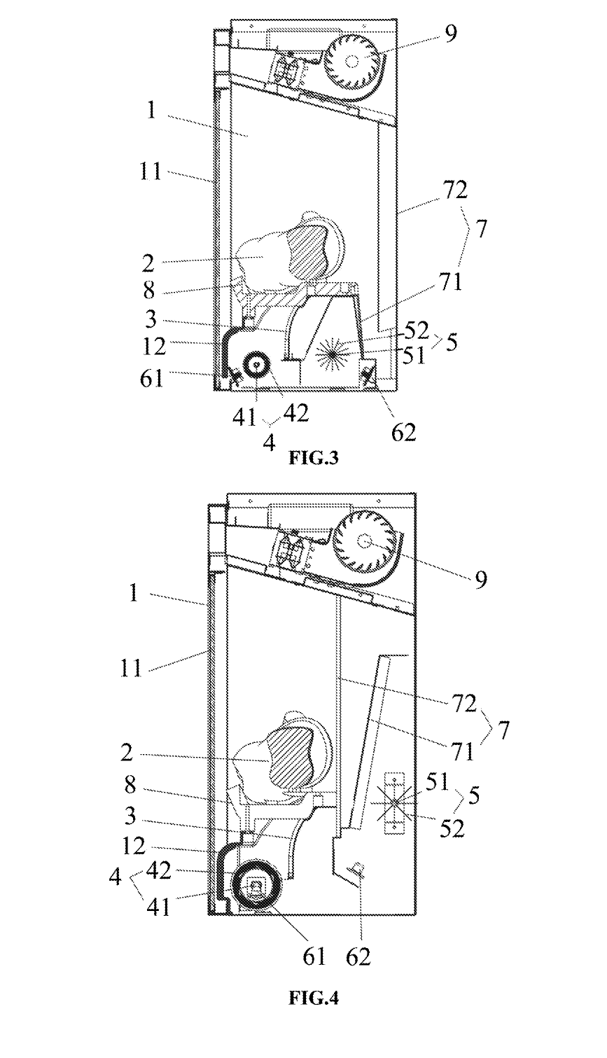

As illustrated in FIG. 3, the electric fireplace providing a 3D flame effect in this embodiment has similar structure as that in embodiment 3, while the difference is the position of the first light-emitting source 61. In this embodiment, the first light-emitting source 61 is arranged outside the revolving drum 42, also to simulate the change of flickering brightness during the burning process of the firewood.

### Embodiment 3

As illustrated in FIG. 4 and FIG. 5, the electric fireplace providing a 3D flame effect in this embodiment has substantially similar structure as that in embodiment 1, while the differences are as follows. In this embodiment, the flame-imaging screen 72 is vertically arranged in the middle of the housing 1, and behind the decorative firelogs 2 and the embers 3; the flame-shaped plate 71 is slantingly arranged between the second. light reflector and the flame-imaging screen 72; the reflector plates 52 of the second light reflector 5 intermittently reflect the light emitted from the second light-emitting source 62 onto the flame-shaped plate 71, through which the reflected light is projected onto the flame-imaging screen 72, to simulate the realistic effect of burning flame.

Embodiment 4

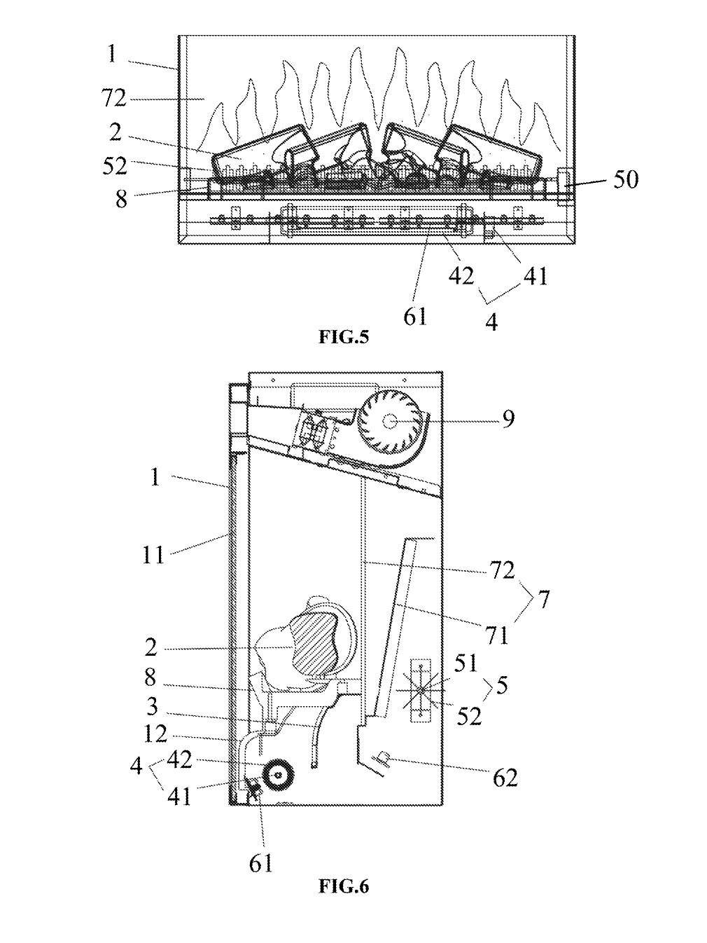

As illustrated in FIG. 6, the electric fireplace providing a 3D flame effect in this embodiment has similar structure as that in embodiment 3, while the difference is the position of the first light-emitting source 61. In this embodiment, the first light-emitting source 61 is arranged outside the revolving drum 42, also to simulate the change of flickering brightness during the burning process of the firewood.

The embodiments disclosed above are only preferred embodiments of the invention. It should be noted that for those skilled in the art, many more improvements and alternatives can be made without departing from the principle of the invention, these improvements and alternatives should also be considered included within the scope of the invention.

1. An electric fireplace providing a 3D flame effect, comprising a housing, and inside the housing, decorative firelogs, embers, a first light projector, a second light reflector, a first light-emitting source, a second light-emitting source and a flame-imaging device;
wherein the first light projector is below a front part of the decorative firelogs and the embers, the first light projector comprises a first actuator and a revolving drum connected with an output shaft of the first actuator, the first light-emitting source is arranged outside the revolving drum, and the revolving drum is used for scattering a light emitted from the first light-emitting source onto the decorative firelogs and the embers;
wherein the flame-imaging device comprises a flame-shaped plate and a flame-imaging screen, the flame-imaging screen is vertically arranged in a middle of the housing and behind the decorative firelogs and embers, and the flame-shaped plate is slantingly disposed between the second light reflector and the flame-imaging screen;
wherein the second light reflector is arranged in a lower rear part of the housing, the second light reflector is used for reflecting a light emitted from the second light-emitting source onto the flame-imaging screen through the flame-shaped plate.

2. The electric fireplace providing a 3D flame effect according to claim 1, characterized in that the revolving drum is a transparent revolving drum which is polygonally shaped in cross-section.

3. The electric fireplace providing a 3D flame effect according to claim 1, characterized in that the revolving drum is provided with a plurality of light transmitting apertures.

4. The electric fireplace providing a 3D flame effect according to claim 3, characterized in that the light transmitting apertures are embedded with condensing tens lenses.

5. (canceled)

6. (canceled)

7. The electric fireplace providing a 3D flame effect according to claim 1, characterized in that the second light reflector comprises a second actuator, a rotation shaft connected with an output shaft of the second actuator, and a plurality of groups of reflector plates arranged along an axis of the rotation shaft, wherein each group of reflector plates comprises a plurality of reflector plates which are radially mounted on the rotation shaft.

8. (canceled)

9. (canceled)

10. (canceled)

11. The electric fireplace providing a 3D flame effect according to claim 1, characterized in that the decorative firelogs and the embers are installed in a lower part of the housing by a firelog bed.

12. The electric fireplace providing a 3D flame effect according to claim 1, characterized in that the housing is further arranged with an electric warm air blower in an upper part.

13. The electric fireplace providing a 3D flame effect according to claim 1, characterized in that the housing is further arranged with an inspection window in a front wall.
